(19) United States
(12) Patent Application Publication
(10) Pub. No.: US 2026/0056429 A1
(43) Pub. Date: Feb. 26, 2026

(54) Electrical Connection Structure for One or More Segments of a Smart Dimming Film

(71) Applicants: FEW Fahrzeugelektrik Werk GmbH & Co. KG, Zwenkau (DE); FEW Automotive FPC Application Co., Ltd, Shenzhen (CN)

(72) Inventors: Xiongbin Gu, Shenzhen (CN); Ying Leibnitz, Leipzig (DE); Peter Thomas Krabs, Leipzig (DE); Andreas Knoll, Oelsnitz (DE)

(73) Assignees: FEW Fahrzeugelektrik Werk GmbH & Co. KG, Zwenkau (DE); FEW Automotive FPC Application Co., Ltd, Shenzhen (CN)

(21) Appl. No.: 19/304,015

(22) Filed: Aug. 19, 2025

(30) Foreign Application Priority Data
Aug. 23, 2024 (CN) 2024220640404

(51) Int. Cl. G02F 1/1334; G02F 1/1333

(52) U.S. Cl. CPC G02F 1/1334; G02F 1/133305; G02F 1/133385

(57) ABSTRACT

This disclosure provides an electrical connection structure of one or more segments of intelligent dimming films, which specifically comprises a dimming film body, a flexible circuit board and a control unit. Among them, U-shaped long grooves are designed between the independent circuits of the flexible circuit board, and ventilation holes are set on the conductive adhesive film layer connecting the dimming film body and the flexible circuit board. The design of the electrical conduction structure of the dimming film of this disclosure not only uses ACF conductive adhesive lamination instead of solder paste welding technology to avoid the risk of circuit false soldering, but also performs special design on FPC and ACF conductive adhesive to improve the operating stability of the dimming film and avoid the risk of short circuit and open circuit caused by line connection.

### TECHNICAL FIELD

This disclosure relates to dimming films, specifically to an electrical connection structure for one or more segments of a smart dimming film.

### Background Technology

Existing dimming films use a simple ACF (Anisotropic Conductive Film) lamination process. This process is affected by the random distribution of conductive particles in the ACF, which poses risks of short circuits and open circuits at the connection between the external control device and the internal parts of the dimming film.

A magnetic stir bar for use with magnetic stir plates, including oriented blades designed to direct liquid flow upward or downward based on blade handedness and rotational direction of the magnetic stir driver.

### SUMMARY OF THE INVENTION

To overcome the shortcomings of the prior art, this disclosure provides an electrical connection structure for one or more segments of a smart dimming film. The design of the electrically conductive structure of the dimming film achieves fault-free connectivity between the dimming film body and the control unit.

To achieve the above objective, this disclosure provides the following technical solution:

An electrical connection structure for one or more segments of a smart dimming film, compromising:
A dimming film body, comprising a control zone and several dimming zones, each of said dimming zones being provided with a dimming film and metal wires, said metal wires being led out and converged to said control zone;
a flexible printed circuit board, said flexible printed circuit board sequentially comprising, from bottom to top, a first insulating layer, several independent circuits, and a second insulating layer, wherein a portion of said first insulating layer of said flexible printed circuit board laminated to said control zone is removed, and the exposed independent circuits are fixed to said metal wires via a conductive adhesive film layer, thereby connecting with said metal wires in said control zone;
a control unit, controlling said dimming film via said flexible printed circuit board;
Wherein,
the connection portion between said dimming film body and said flexible printed circuit board forms an electrically conductive structure;
the said conductive adhesive film layer is provided with ventilation holes, said ventilation holes being disposed between said independent circuits and said metal wires;
U-shaped elongated slots are provided between the independent circuits of said flexible printed circuit board.

Specifically, said dimming film is a Polymer Dispersed Liquid Crystal (PDLC) film.

Specifically, said metal wires are located at the conductive contacts of the top-layer of the dimming film or the bottom-layer of the dimming film.

Specifically, a cover layer is provided on the side of the second insulating layer of said control zone, the material of said cover layer being epoxy resin adhesive or polyimide film, used to enhance the tensile strength of said flexible printed circuit board.

Specifically, the U-shaped elongated slots on said flexible printed circuit board have a length of 5 mm to 8 mm and a width of 1 mm to 2 mm.

Specifically, the ventilation holes provided on said conductive adhesive film layer are circular ventilation holes with a diameter of 1 mm to 2 mm.

Specifically, the thickness of said conductive adhesive film layer is 20μm to 30 μm.

Specifically, the thickness ratio between the insulating layer of said flexible printed circuit board, the conductive copper layer, and the conductive adhesive film layer is approximately 3:2:2.

Specifically, the width of said metal wires and the spacing between their center points are 2 mm to 3 mm.

Compared with the prior art, the advantages of this disclosure are as follows: The connection between the FPC (Flexible Printed Circuit) board and the dimming film enables switch control of multiple regions of the dimming film while avoiding complex wiring; U-shaped elongated slots are designed between the independent circuits of the FPC board to increase the non-pressurized surface, isolating the anisotropic conductive film (ACF) between two independent circuits, thereby avoiding the risk of short circuits between adjacent independent circuits; Circular ventilation holes are designed on the ACF conductive adhesive to facilitate exhaust during lamination, improving the flatness of the ACF lamination, preventing lamination bubbles from affecting the contact of conductive particles, and avoiding poor conduction between the FPC board and the smart dimming film, which could lead to open circuit risks. A cover layer (made of epoxy resin adhesive or polyimide film) is filled on the non-laminated open surface of the FPC board to enhance the tensile strength of the FPC.

### DESCRIPTION OF DRAWINGS

To more clearly illustrate the technical solutions of the embodiments of this application, the drawings required for the embodiments are briefly introduced below. It is obvious that the drawings described below are only some embodiments of this application, and those skilled in the art can obtain other drawings based on these drawings without creative effort.

FIG. 1 is a schematic diagram of the completed connection between the flexible printed circuit board and the dimming film body in an embodiment of this disclosure.

FIG. 2 is a cross-sectional schematic diagram of the completed connection between the flexible printed circuit board and the dimming film body in an embodiment of this disclosure.

FIG. 3 is a schematic diagram of the flexible printed circuit board in an embodiment of this disclosure.

FIG. 4 is a schematic diagram of the conductive adhesive film layer in an embodiment of this disclosure.

FIG. 5 is a schematic diagram of the cover layer (made of epoxy resin adhesive or polyimide film) in an embodiment of this disclosure.

### DETAILED DESCRIPTION

The embodiments of this application are described in detail below with reference to the accompanying drawings.

The embodiments of this application are described through specific examples, and those skilled in the art can easily understand the other advantages and effects of this application from the content disclosed in this specification. It is obvious that the embodiments described are only a part of the embodiments of this application, not all of them. This application can also be implemented or applied through other different specific embodiments, and various details in this specification can be modified or changed based on different perspectives and applications without departing from the spirit of this application. It should be noted that, in the absence of conflict, the embodiments and features within the embodiments can be combined with each other. Based on the embodiments in this application, all other embodiments obtained by those skilled in the art without creative effort fall within the scope of protection of this application.

It should be noted that the various aspects of the embodiments described below fall within the scope of the appended claims. It is obvious that the aspects described herein can be embodied in a wide variety of forms, and any specific structure and/or function described herein is merely illustrative. Based on this application, those skilled in the art should understand that one aspect described herein can be implemented independently of any other aspect, and two or more of these aspects can be combined in various ways. For example, an apparatus can be implemented and/or a method can be practiced using any number and aspect described herein. Additionally, such an apparatus and/or method can be implemented using other structures and/or functionalities in addition to one or more of the aspects described herein. It should also be noted that the illustrations provided in the following embodiments merely illustrate the basic concept of this application in a schematic manner. The drawings only show components related to this application, rather than being drawn according to the number, shape, and size of components in actual implementation. In actual implementation, the type, quantity, and proportion of each component may be arbitrarily changed, and the component layout may be more complex.

Furthermore, in the following description, specific details are provided to facilitate a thorough understanding of the examples. However, those skilled in the art will understand that the aspects can be practiced without these specific details.

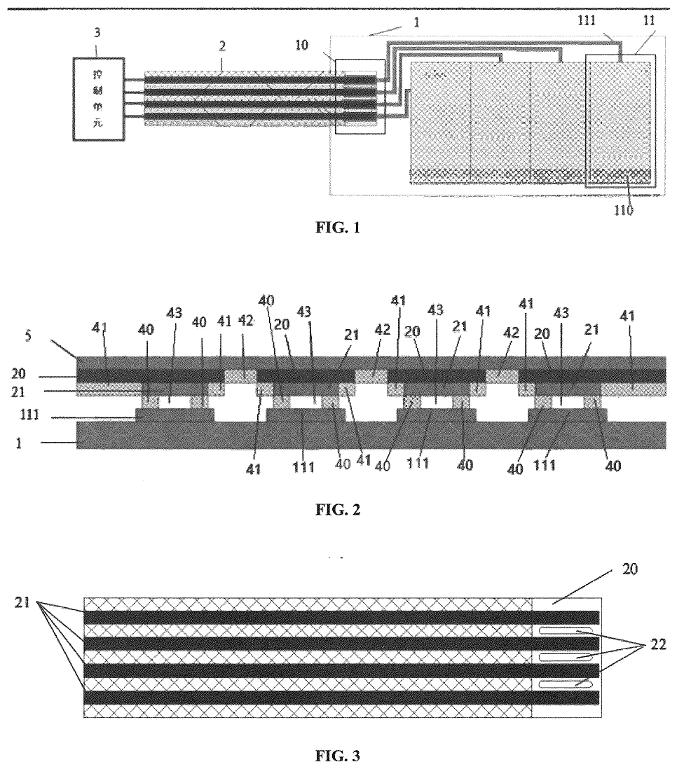

This disclosure provides an electrical connection structure for one or more segments of a smart dimming film, as shown in FIG. 1, comprising: a dimming film body (1), a flexible printed circuit board (2), and a control unit (3).

The connection portion between the dimming film body and the flexible printed circuit board forms an electrically conductive structure.

The dimming film body (1) includes a control zone (10) and several dimming zones (11). The dimming zones (11) are provided with a dimming film (110) and metal wires (111). The metal wires (111) are led out from each dimming film (110), converged to the control zone (10) of the dimming film body (1), and arranged in the control zone (10).

In one embodiment, the dimming film is a Polymer Dispersed Liquid Crystal (PDLC) film, and the metal wires are located at the conductive contacts of the top-layer or bottom-layer of the dimming film. The flexible printed circuit board (2) connects to the dimming film body (1) in the control zone (10) via a conductive adhesive film layer (4). The complete flexible printed circuit board (2) sequentially comprises, from bottom to top, a first insulating layer, several independent circuits, and a second insulating layer. When connecting the flexible printed circuit board (2) to the dimming film body (1), a portion of the first insulating layer of the flexible printed circuit board (2) in the control zone (10) is removed, retaining several independent circuits (21) and the second insulating layer (20). The exposed independent circuits (21) are fixed to the metal wires in a one-to-one correspondence via the conductive adhesive film layer (4), and the independent circuits (21) and metal wires (111) are connected in the control zone (10).

In one embodiment, the conductive adhesive film layer is an Anisotropic Conductive Film (ACF), which is a film formed by incorporating a certain amount of conductive particles into a polymer matrix. Before bonding, the conductive particles in the anisotropic conductive adhesive are generally distributed approximately uniformly, without mutual contact, and are protected by an insulating film, making the ACF film itself non-conductive. When pressure and heat are applied to the ACF film, it softens (becoming gelatinous), allowing the conductive particles to flow and distribute evenly, ensuring a certain number of conductive particles per circuit to maintain stable resistance. Under bonding pressure, the insulating film of the conductive particles breaks, and multiple deformed conductive particles are sandwiched between the bumps on the circuit and the corresponding metal wires on the dimming film substrate, achieving electrical interconnection between the upper and lower bumps through these deformed conductive particles. The particles in other non-pressurized areas do not contact each other, thus achieving anisotropic interconnection.

In one embodiment, as shown in FIG. 3, U-shaped elongated slots (22) are provided between the independent circuits (21) in the control zone (10), with the second insulating layer (20) between the independent circuits (21) removed. When the exposed independent circuits (21) are fixed to the metal wires (111) in a one-to-one correspondence via the conductive adhesive film layer (4), the conductive adhesive film layer (4) exists in three positional states: The conductive adhesive film layer (40) located between the independent circuits (21) and the metal wires (111), which is in a fully pressurized state and fully conductive; The conductive adhesive film layer (41) located at the angle between the second insulating layer (20) and the independent circuits (21), which is in a semi-pressurized state and poses a risk of conduction; The conductive adhesive film layer (42) located in the U-shaped elongated slots (22), which is in a non-pressurized state and completely non-conductive. The provision of U-shaped elongated slots (22) increases the non-pressurized surface of the conductive adhesive film layer, ensuring that the conductive adhesive film layer (42) in the U-shaped elongated slots (22) is completely non-conductive, isolating the electrical connection of the conductive adhesive film layer (4) between two independent circuits (21), and avoiding the risk of short circuits between adjacent independent circuits (21).

In one embodiment, the U-shaped elongated slot (22) on said flexible printed circuit board (2) have a length of 5 mm to 8 mm and a width of 1 mm to 2 mm.

In one embodiment, a cover layer (5) (made of epoxy resin adhesive or polyimide film) is provided on the side of the second insulating layer (20) in the control zone (10) to enhance the tensile strength of the flexible printed circuit board (2).

In one embodiment, the thickness of said conductive adhesive film layer (4) is 20 μm to 30 μm.

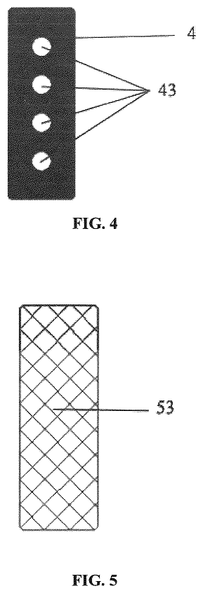

In one embodiment, as shown in FIG. 4, ventilation holes (43) are provided on the conductive adhesive film layer (4), located between the independent circuits (21) and the metal wires (111), to facilitate exhaust during lamination of the conductive adhesive film layer (4) and the flexible printed circuit board, preventing lamination bubbles, improving the flatness of the conductive adhesive film layer (4), reducing poor contact of conductive particles, and avoiding poor conduction between the independent circuits (21) and the metal wires (111), which could lead to open circuit risks.

In one embodiment, as shown in FIG. 4, the ventilation hole (43) is circular ventilation hole with a diameter of 1 mm to 2 mm.

In one embodiment, the thickness ratio between the insulating layer (20) of the flexible printed circuit board (2), the circuit layer (21) of the flexible printed circuit board, the conductive adhesive film layer (4), and the metal wires (111) is approximately 3:2:2.

The control unit (3) is connected to the dimming film (1) via the flexible printed circuit board (2) to control the dimming film.

In one embodiment, when the space for the dimming film is limited and the metal wires are short, preventing the metal wires from converging to adjacent positions, the end of the FPC with the second insulating layer removed and U-shaped elongated slots provided between the independent circuits is extended. The end of the flexible printed circuit board is pulled to the metal wires, and the exposed independent circuits are fixed to the metal wires in a one-to-one correspondence via the conductive adhesive film layer. Ventilation holes are provided on the conductive adhesive film layer, located between the independent circuits and the metal wires, to facilitate exhaust during lamination of the conductive adhesive film layer and the FPC end, preventing lamination bubbles, improving the flatness of the conductive adhesive film layer, reducing poor contact of conductive particles, and avoiding poor conduction between the independent circuits and the metal wires, which could lead to open circuit risks.

I claim:

1. An electrical connection structure for one or more segments of a smart dimming film, compromising:
a dimming film body, comprising a control zone and several dimming zones, each of said dimming zones being provided with a dimming film and metal wires, said metal wires being led out and converged to said control zone;
a flexible printed circuit board, said flexible printed circuit board sequentially comprising, from bottom to top, a first insulating layer, several independent circuits, and a second insulating layer, wherein a portion of said first insulating layer of said flexible printed circuit board laminated to said control zone is removed, and the exposed independent circuits are fixed to said metal wires via a conductive adhesive film layer, thereby connecting with said metal wires in said control zone; and
a control unit, controlling said dimming film via said flexible printed circuit board, wherein
the connection portion between said dimming film body and said flexible printed circuit board forms an electrically conductive structure;
the said conductive adhesive film layer is provided with ventilation holes, said ventilation holes being disposed between said independent circuits and said metal wires; and
U-shaped elongated slots are provided between the independent circuits of said flexible printed circuit board.

2. An electrical connection structure for one or more segments of a smart dimming film according to claim 1, wherein the dimming film is a Polymer Dispersed Liquid Crystal (PDLC) film.

3. An electrical connection structure for one or more segments of a smart dimming film according to claim 1, wherein the metal wires are located at the conductive contacts of the top-layer of the dimming film or the bottom-layer of the dimming film.

4. An electrical connection structure for one or more segments of a smart dimming film according to claim 1, wherein a cover layer is provided on the side of the second insulating layer of said control zone, the material of said cover layer being epoxy resin adhesive or polyimide film, used to enhance the tensile strength of said flexible printed circuit board.

5. An electrical connection structure for one or more segments of a smart dimming film according to claim 1, wherein the U-shaped elongated slots on said flexible printed circuit board have a length of 5 mm to 8 mm and a width of 1 mm to 2 mm.

6. An electrical connection structure for one or more segments of a smart dimming film according to claim 1, wherein the ventilation holes provided on said conductive adhesive film layer are circular ventilation holes with a diameter of 1 mm to 2 mm.

7. An electrical connection structure for one or more segments of a smart dimming film according to claim 1, wherein the thickness of said conductive adhesive film layer is 20 μm to 30μm.

8. An electrical connection structure for one or more segments of a smart dimming film according to claim 1, wherein the thickness ratio between the insulating layer of said flexible printed circuit board, the conductive copper layer, and the conductive adhesive film layer is approximately 3:2:2.

9. An electrical connection structure for one or more segments of a smart dimming film according to claim 1, wherein the width of said metal wires and the spacing between their center points are 2 mm to 3 mm.
